(19) United States
(12) Patent Application Publication
(10) Pub. No.: US 2003/0079983 A1
(43) Pub. Date: May 1, 2003

(54) Multi-zone RF electrode for field/plasma uniformity control in capacitive plasma sources

(76) Inventors: Maolin Long, Guangzhou (CN); Richard Parsons, Phoenix, AZ (US); Wayne Johnson, Phoenix, AZ (US)

Correspondence Address: PILLSBURY WINTHROP, LLP, P.O. BOX 10500, MCLEAN, VA, 22102, US

(21) Appl. No.: 10/227,527

(22) Filed: Aug. 26, 2002

Related U.S. Application Data
(63) Continuation of application No. PCT/US01/04562, filed on Feb. 14, 2001.
(60) Provisional application No. 60/185,069, filed on Feb. 25, 2000.

(51) Int. Cl. B01J 19/08

(52) U.S. Cl. 204/164; 422/186.04; 422/186.29

(57) ABSTRACT

A method and apparatus for generating and controlling a plasma formed in a capacitively coupled plasma source having a plasma electrode and a bias electrode, the plasma electrode being composed of a plurality of sub-electrodes that are electrically insulated from one another and the plasma being formed in a plasma region between the plasma electrode and the bias electrode, the plasma being generated and controlled by: coupling RF power to the plasma region via each sub-electrode; and causing the RF power coupled via one of the sub-electrodes to be able to differ in at least one of power, frequency, phase, and waveform from the RF power coupled via another one of the sub-electrodes.

This application is a continuation application of International Application No. PCT/US01/04562, filed Feb. 14, 2001 and derives the benefit of U.S. Provisional application 60/185,069, filed Feb. 25, 2000, the contents of both are incorporated herein by reference.

### BACKGROUND OF THE INVENTION

The present invention relates to capacitively coupled plasma sources of the type including two electrodes forming capacitor plates between which a radio frequency (RF) field is established in order to form a plasma composed of ions of a gas introduced into the space between the electrodes. A plasma is composed of not only ions, but also electrons, molecules, radicals, etc.

Such plasma sources are employed for performing layer deposition and etching processes on a substrate, such as a semiconductor wafer, disposed in a processing chamber.

Capacitively coupled plasma sources for etch and deposition purposes usually have two parallel electrodes, which also act as capacitor plates, installed in the processing chamber. One electrode is connected to a first RF power supply for plasma generation and will be referred to hereinafter as a plasma electrode. The other electrode, on which the wafer or substrate is placed, is connected to a second RF power supply which creates a DC self-bias at the wafer surface. This other electrode will be referred to hereinafter as a bias electrode.

There are two types of capacitive electrode design structures, symmetrical and asymmetrical, based on the relative sizes of the two electrodes. In the symmetrical type, the two electrodes have the same size. In the asymmetrical type, the two electrodes have respectively different sizes. Because of this structural difference, these two types of designs have respectively different distribution profiles across the two regions extending between the two electrodes with respect to ionization rate (R) and plasma potential (V). This technology is described in High Density Plasma Sources—Design, Physics and Performance, Popov, Oleg A., (ed.), Noyes Publications, Park Ridge, N.J. (1995).

FIG. 1a shows a symmetrical electrode arrangement, FIG. 1b shows the ionization rate (R) and FIG. 1c shows plasma potential (V) distribution profiles for this electrode arrangement. FIG. 1d shows an asymmetrical electrode arrangement, FIG. 1e shows the ionization rate (R) and FIG 1f shows plasma potential (V) distribution profiles for the electrode arrangement of FIG. 1d.

When the plasma electrode is partitioned into several sub-electrodes, as disclosed in U.S. Pat. No. 5,252,178, and each sub-electrode is driven by a separate RF power supply, a typical asymmetrical discharge structure is formed between each sub-electrode and the bias electrode. The effects of partitioning of the plasma electrode are not well understood from the existing theoretical point of view in plasma physics.

In capacitive RF discharges, it is a common practice to generate high density plasmas at frequencies higher than the standard 13.56MHz because plasma density increases with increasing frequency, as does the ratio of power for plasma generation to power consumed for ion acceleration. In addition, the plasma density, nₒ, at the plasma sheath boundary increases with the square of the frequency and the three-quarters power of the pressure, while the sheath thickness, dₛ, decreases with the square root of frequency. Moreover, it has been observed that the plasma uniformity in a highly asymmetric reactor improves as the sheath thickness decreases.

Thus, as frequency increases, over a certain range, internal plasma parameters change in a manner that tends to improve the processing result.

However, the increase of frequency is associated with a reduction in wavelength at the fundamental frequency and/or harmonics, and thus the propagation of RF waves on the surface of the electrodes has an increased effect on the distribution of electric fields between the two electrodes. The electric field uniformity directly affects plasma uniformity and etch or deposition uniformity. Plasma uniformity is also affected by gas-flow and other design asymmetries. For larger wafer sizes, which require larger electrode sizes, the issue of uniformity control becomes more prominent.

### BRIEF SUMMARY OF THE INVENTION

The invention is embodied in a method and apparatus for generating and controlling a plasma formed in a capacitively coupled plasma source having a plasma electrode and a bias electrode, wherein the plasma electrode is a multi-zone, or plural sub-electrode, electrode and RF power is independently controlled at each sub-electrode. In particular, the amplitude, phase, frequency, and/or waveform of the RF signal applied to each sub-electrode may be varied from one sub-electrode to another, thereby affecting the spatial distribution of the electric field and plasma density

### BRIEF DESCRIPTION OF THE SEVERAL VIEWS OF THE DRAWING

FIGS. 1a and 1d are simplified schematic diagrams showing two known electrode arrangements that may be used in a capacitively coupled plasma source, and FIGS. 1b and 1e are diagrams showing ionization rate profiles and FIGS. 1c and 1f are plasma potential distribution profiles with the electrode arrangements of FIGS. 1a and 1d, respectively.

FIGS. 2a and 2b are perspective views showing two plasma electrode structures that can be employed in the practice of the present invention.

FIGS. 2c, 2d and 2e are cross-sectional detail views of a portion of the adjacent area of two sub-electrodes, where they are separated by dielectric or insulating material, for the electrode structure of each of FIGS. 2a and 2b.

FIGS. 3a-3d are plan views of four further plasma electrode structures that can be employed in the practice of the present invention.

FIG. 4 is a simplified schematic diagram of a portion of an electrode structure to illustrate the field distribution on the wafer surface in the adjacent area between two sub-electrodes.

FIGS. 5a and 5c are simplified schematic diagrams showing the known electrode arrangement of FIG. 1a and an electrode arrangement that can be used in the practice of the present invention, respectively, and FIGS. 5b and 5d are equivalent circuit diagrams of the arrangements shown in FIGS. 5a and 5c, respectively.

FIG. 6 is a perspective view of a connection arrangement for a plasma electrode that can be used in the practice of the present invention.

FIGS. 7 and 8 are perspective views of connection arrangements for two plasma electrodes that can be used in the practice of the present invention.

FIGS. 9, 10 and 11 are block diagrams of models that can be used in the control of field/plasma uniformity according to the present invention.

FIGS. 12 to 17 are schematic diagrams of various control schemes that can be used in the practice of the present invention

FIGS. 18a and 18b are respectively, a side elevational cross-sectional view and a top plan view of one embodiment of the top portion of plasma processing apparatus that may be constructed and operated according to the present invention.

FIG. 19 is a view similar to that of FIG. 18a of a second embodiment of the top portion of plasma processing apparatus that may be constructed and operated according to the present invention.

FIG. 20 shows a control block diagram for improving plasma uniformity according to the present invention.

FIG. 21 is a pictorial plan view of a segmented plasma electrode provided with gas flow passages according to the present invention.

FIG. 22 is a schematic diagram of an arrangement for supplying process gas to a segmented plasma electrode according to the present invention.

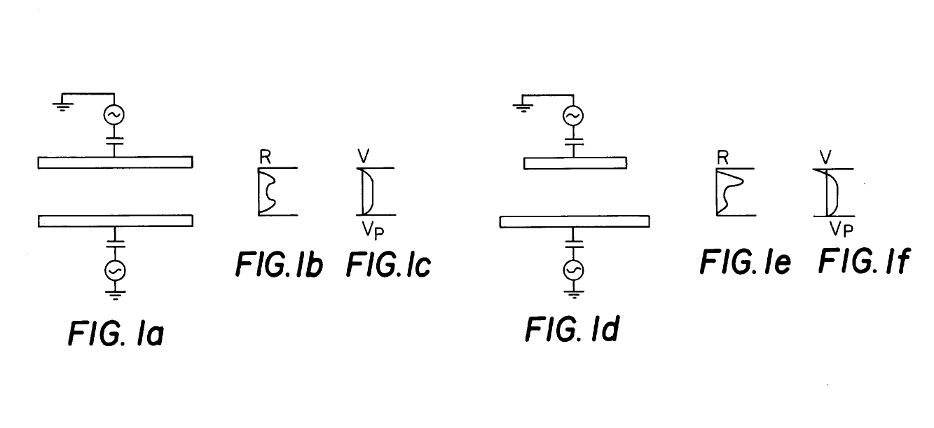

### DETAILED DESCRIPTION OF THE INVENTION

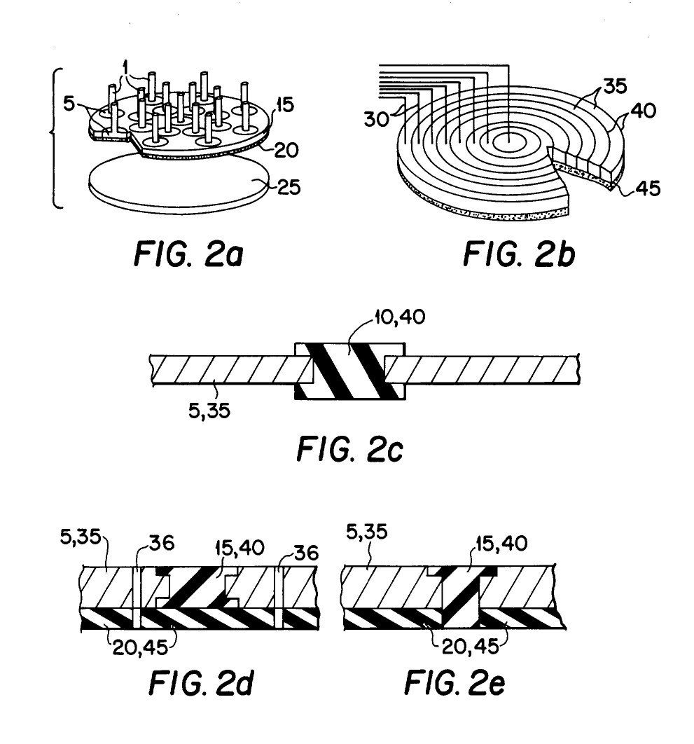

FIGS. 2a and 2b show two typical cases of multi-zone RF plasma electrodes which may be used in the practice of the present invention. Each plasma electrode is divided into several sub-electrodes and each sub-electrode is connected to be excited by an independent RF power supply with a controllable power level, frequency, phase angle, and waveform. The power level produced by each power supply may be controlled by varying one or both of the output current and voltage. These smaller sub-electrodes of the plasma electrode, 5 in FIG. 2(a) and 35 in FIG. 2(b), are simply independent plasma sub-electrodes having a common bias electrode 25 in FIG. 2(a) and not shown in FIG. 2b, to form asymmetrical discharge structures.

In many cases, it may be necessary to include an additional plate, or film, 20 in FIG. 2a and 45 in FIG. 2b, on the surface of the plasma electrode to prevent direct contact between the electrode and the plasma. The plasma electrode and its associated plate, or film, 20, 45 will be provided with perforations, or gas holes, for the passage of processing gas that is to be introduced into the plasma region. The material of plate, or film, 20, 45 should be such that no damage or contamination will be caused to the substrate when the plate is sputtered or etched. Each plate 20, 45 may be constituted by a plurality of individual plates, each associated with a respective sub-electrode and each electrically insulated from adjacent plates.

For oxide etching, the material for plates 20 and 45 may be silicon or other alternatives as long as no harmful particles are produced in the chamber and thus no contamination is introduced to the substrate.

In FIG. 2a, sub-electrodes 5 are insulated from one another by being held in bores in a plate 15 of electrical insulating material. In FIG. 2b, adjacent sub-electrodes 35 are insulated from one another by circular insulation walls 40. The design of plate 15 and insulation walls 40 and the spatial arrangement of the sub-electrodes must be selected to avoid arcing between adjacent sub-electrodes because a relatively small RF voltage on each sub-electrode may result in remarkable RF potential difference between two adjacent sub-electrodes when they are not driven in phase.

In addition, at least when a plate 20, 45 is not provided, the front surfaces of the sub-electrodes may be recessed relative to insulation walls 40, as shown in the detail view of FIG. 2c, in order to increase the minimum length of arcing paths between adjacent sub-electrodes 35.

FIGS. 2d and 2e illustrate, in cross section, two possible forms of construction for sub-electrodes 5, 35, plate 15 or walls 40, and plate 20 or 45 at the edges of the sub-electrodes. The structure shown in FIG. 2d is suitable when plate 20, 45 is made of a material which provides sufficient electrical insulation between adjacent sub-electrodes; otherwise, the structure shown in FIG. 2e would be appropriate.

RF feeds 1 in FIG. 2a and 30 in FIG. 2b are each RF shielded up to points as close as possible to the back surfaces of the sub-electrodes to avoid RF interference among the sub-electrodes.

FIG. 2d also shows that each sub-electrode 5, 35 can be provided with a plurality of gas flow passages 36 via which process gas will be introduced into the plasma region. Arrangements for supplying gas to passages 36 will be described at a later point herein.

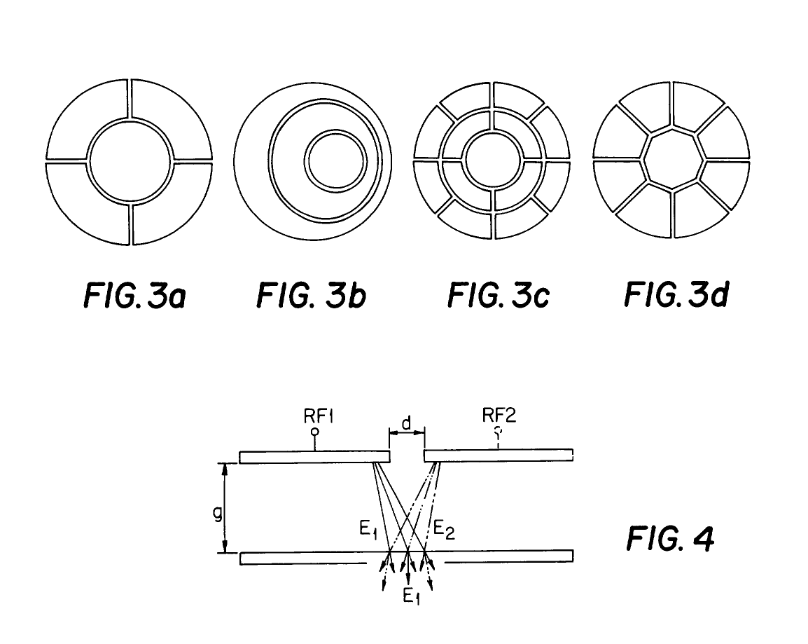

Plasma electrodes used in the practice of the present invention can have a wide variety of configurations in addition to those shown in FIGS. 2a and 2b. FIGS. 3a, 3b, 3c and 3d show a few examples of other suitable multi-zone configurations. FIGS. 3a, 3c and 3d show sub-electrode configurations that employ circumferential and radial partitioning of the electrode surface in order to compensate for radial and/or circumferential non-uniformities. FIG. 3b shows an arbitrarily selected arrangement biased in space to alleviate field non-uniformity by direct spatial compensation; i.e., the sub-electrode configuration directly mimics the shape of the non-uniformity. The number of zones, or sub-electrodes, is mainly determined by the physical size of the RF feeds, i.e., the RF amplifier and/or impedance match network connected to each sub-electrode, and the uniformity requirements.

There are two size considerations, namely the sub-electrode size and the physical size of the RF components, that should be taken into account for selection of the sub-electrode pattern. This will be addressed more fully below. It might be noted that the greater number of sub-electrodes, the greater the spatial resolution of control.

However, there are practical limitations, for example, the larger the number of sub-electrodes, the greater the cost and complexity of the electrode. Furthermore, there is a size limitation on the number of RF components that can access an array of sub-electrodes. Although decreasing the sub-electrode size, and hence the area and power requirements per sub-electrode, coincides with a decrease in size of the necessary RF components to facilitate driving each sub-electrode, the physical size of these RF components does not decrease at the same rate.

In general, the more sub-electrodes, the better the global uniformity.

The selection of a specific sub-electrode geometry depends on the field/plasma uniformity characteristics of a particular apparatus when that apparatus is provided with a homogenous, or unpartitioned, plasma electrode. There are two reasons for this. Firstly, measurements of the RF field/plasma uniformity in a chamber having an unpartitioned plasma electrode can be used to determine spatial resolution in the sub-electrode design local to the non-uniformity, i.e., the sub-electrode configuration can mimic the spatial variation of the field/plasma. For example, the sub-electrodes can be made smaller near large gradients in the field/plasma. The number of sub-electrodes and their placement can improve the spatial resolution of the field control. Secondly, investigation of the RF field distribution on the unpartitioned plasma electrode may enable decomposition of the spatial variation into wave-number space, thereby identifying those wave-numbers, or wavelengths, that predominantly contribute to the non-uniformity.

Given identification of the wavelength, i.e., δₛₑ<<λ, where λ is a critical harmonic and δₛₑ is a characteristic length scale for a sub-electrode, an example of the spatial distribution of the RF field on an electrode is derived from a reduced form of Maxwell's equations that has the form of a “wave” equation. A solution to the wave equation for waves propagating on a circular, or cylindrical, surface that are of equal phase at a given radial location on the electrode (i.e., a circumferentially symmetric wave field such that circles of constant radius are constant phase, is the first order Bessel function of the first kind, viz.

E(r)∝Jₒ(βr),

where E(r) is the radial variation of the normal electric field and β is the propagation constant or wave-number (2π/λ). Therefore, the smaller the wavelength, the more pronounced the radial variation.

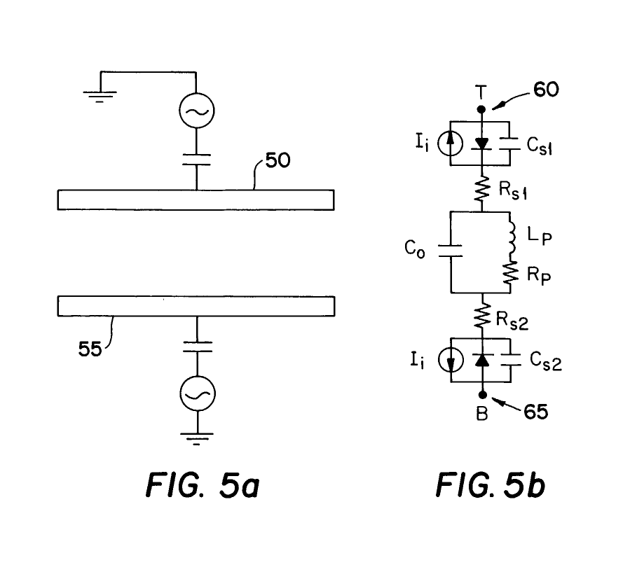

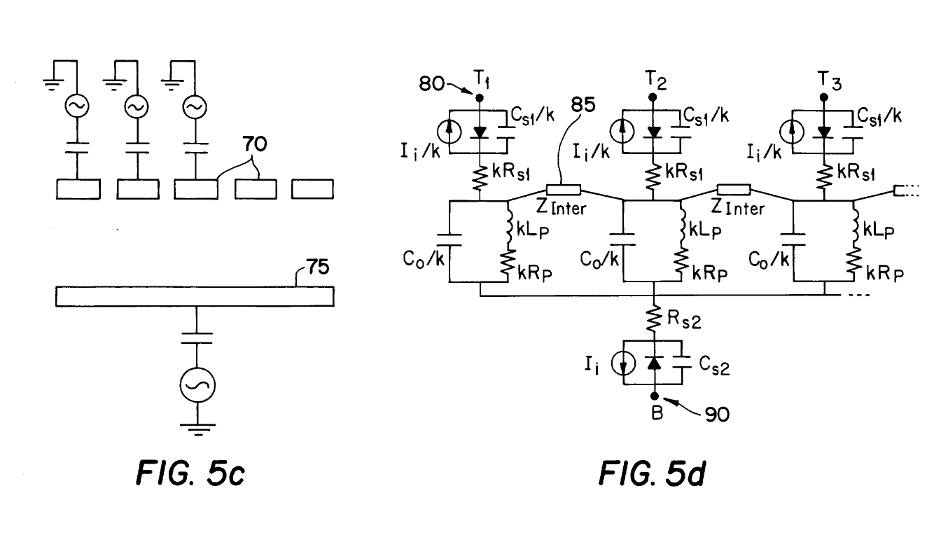

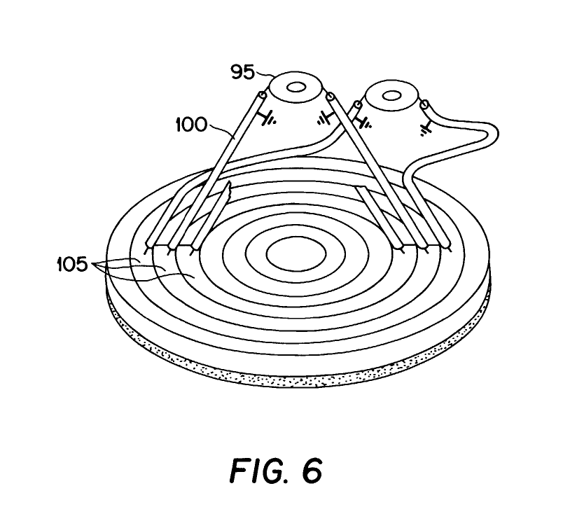

By adjusting the RF power source, including its power (or voltage and/or current), frequency, phase angle, and waveform, for each individual sub-electrode, the configuration of the local electric field is controlled. Coordination among the RF control of the individual sub-electrodes accomplishes the adjustment of the global field uniformity. Moreover, because the sub-electrodes have relatively small areas, the plasma impedance between each sub-electrode and the bias electrode is correspondingly high, as will be discussed below with reference to FIG. 5. These high impedances release the burden on the match networks and the RF power supplies and may even make it unnecessary to use match networks, as will be discussed below. The smaller areas of the sub-electrodes yield a reduced effect of RF wave propagation on local field uniformity. This advantage is further reflected in the fact that the increase of impedance seen by each sub-electrode also makes it easier to adjust harmonic contents in plasma by use of filters/traps with relatively lower Q value to achieve required harmonic attenuation and thus better local uniformity.

The concept of multi-zone electrodes is already known per se. An electrode structure in the form of a showerhead assembly composed of three concentric sub-electrodes is disclosed in issued U.S. Pat. Nos. 5,464,499, 5,286,297, and 5,252,178 (Moslehi et al). Experiments have been performed with such an electrode structure in which different levels of RF power were delivered to different sub-electrodes of the showerhead to control the uniformity of the plasma. However, many in-depth questions about the internal change of plasma caused by the introduction of the multi-zone electrode and the inherent characteristics in asymmetric discharge remain unexplored and there is no existing method that describes systematically how the RF supply source should be adjusted to achieve desired plasma properties and better uniformity.

The partition of a plasma electrode into sub-electrodes brings along some properties which have not been considered in the prior art, such as the reduced effect of RF wave propagation on field and plasma uniformity and the plasma impedance seen by each sub-electrode. Non-uniformity problems may be caused by design asymmetries, such as that which may be due to the chamber opening for load lock, and these cannot be solved by the annular structure shown in FIG. 2b. In contrast, the asymmetrical configuration shown in FIG. 3b might alleviate such non-uniformity problems. In general, the details of partition of the plasma electrode and associated uniformity control strategy are case-specific.

Plasma uniformity includes uniformity in plasma density, ion energy distribution, electron temperature, plasma potential, ionization rate, sheath thickness, etc. To adjust these internal plasma parameters independently to a certain degree, more than one control variable (e.g., power, frequency, phase angle, waveform etc.) can desirably be used simultaneously. In the prior art, only power level is used as a control variable with a partitioned plasma electrode.

According to the present invention, multiple variables can be used for uniformity control, including power (or voltage and/or current), frequency and/or phase angle. The waveforms of the output of the RF power supply may also serve as a control variable to promote field/plasma uniformity according to the invention. In summary, the concept presented herein involves a segmented plasma electrode in which the geometry and characteristic size of each sub-electrode, and the RF power, frequency, and possibly phase and waveform are adjusted to promote improved plasma uniformity.

A plasma electrode can be partitioned into sub-electrodes according to the invention to provide an asymmetric discharge structure, in contrast a homogenous plasma electrode having the same outer dimensions. This causes changes in internal parameters of the plasma. In addition, the field/plasma distribution in the area between two adjacent sub-electrodes becomes very complicated.

Referring to FIG. 4, the field distribution in a region between two sub-electrodes in the presence of a plasma is very difficult, if not impossible, to analyze theoretically. An alternative way is to analyze the field distribution when no plasma is being produced. This analysis will give some indication of the field distribution when a plasma is present. The field vector E_{T} in the region between two sub-electrodes is the vector summation of the field vectors produced by each of the two sub-electrodes, i e., E₁ and E₂.

When there is no plasma, the simplest case is that the two adjacent sub-electrodes are driven by two RF power sources operating at the same power level, frequency and phase angle. In this case, the direction of E_{T} depends on the location and is fixed, at least if the RF travel time difference caused by the discharge gap difference is neglected, but its amplitude alternates at the RF frequency. Only the field along the center line between the two adjacent sub-electrodes is in the direction perpendicular to the wafer surface.

For the same case, except only that there is a phase shift between the two RF sources, both the direction and amplitude of the field on the surface of the wafer are time-varying and there is no place in the adjacent area where the field has a constant direction. The field vector rotates at the RF frequency and its amplitude alternates at the same frequency. The initial angular position of the rotating field vector depends on the phase shift and the location. If this happens under process conditions with a plasma being maintained, anisotropy in the adjacent area is degraded. The resulting isotropy is symmetric about the center line of the adjacent area. The phase shift can happen even if the RF sources for the two adjacent sub-electrodes have the same power level, frequency, and phase angle, because the unbalance of the RF circuits connecting the RF sources to the sub-electrodes can cause a phase shift between the RF waves arriving at the surfaces of the two sub-electrodes. Thus, RF sources with adjustable phase angle will provide an effective way to tune the phase shift between the two adjacent sub-electrodes to zero.

If an RF power difference can be established between the two adjacent sub-electrodes, in addition to a phase shift as in the above case, the total field vector E_{T} will also be rotating at the RF frequency with an alternating amplitude at the same frequency. Moreover, the isotropy in the adjacent area is no longer symmetric about the center line due to the power difference between the two adjacent sub-electrodes. However, this asymmetry is useful for uniformity adjustment if the phase shift is tuned to zero, which will eliminate the isotropy by removing the rotation of the field vector and allowing only a power difference between sub-electrodes.

If an RF frequency difference is introduced between two adjacent sub-electrodes, the field in the adjacent area becomes much more complicated. Its direction and amplitude will both be modulated at the higher frequency. The alternation of its direction and amplitude also depends on the phase shift, power difference, and location. However, since plasma density increases rapidly with the increase of RF frequency, RF power sources with adjustable frequency are very effective in establishing uniformity among the plasmas generated by the individual sub-electrodes.

There is a trade-off in using RF control for uniformity adjustment and the accompanying isotropy problem in the adjacent area due to the rotation of the total field vector E_{T} in the adjacent area. But the isotropy is reduced by decreasing the separation distance d between the two adjacent sub-electrodes and increasing the discharge gap g between the bias electrode and the plasma electrode, i.e., by reducing the ratio d/g.

A change in the internal plasma parameters is reflected in a change of the plasma impedance seen by each sub-electrode. Since the area of each sub-electrode is smaller than that of a corresponding unpartitioned plasma electrode, each sub-electrode sees a higher impedance than would the corresponding unpartitioned plasma electrode.

FIGS. 5a to 5f show the impedance change due to the partition of the plasma electrode, in terms of equivalent circuits. FIG. 5a shows unpartitioned electrodes and FIG. 5b shows the equivalent circuit for the structure of FIG. 5a, where plasma electrode 50 and bias electrode 55 are not necessarily of the exact same size. This structure is much more symmetrical than one having a partitioned plasma electrode as shown in FIG. 5c and an equivalent circuit as shown in FIG. 5d, which illustrate, simply by way of example, a plasma electrode with only three sub-electrodes 70 being shown to be connected to RF supplies.

The impedance between plasma electrode and bias electrode increases from that between top 60 and bottom 65 as shown in FIG. 5 to that between top 80 and bottom 90 as shown in FIG. 5d. As can be seen in FIG. 5d, the impedance between each sub-electrode 70 and the common bias electrode 75 becomes more complicated in analysis and calculation because of the introduction of interconnecting impedance 85 (Z_{Inter}). Z_{Inter} is different for different RF control schemes and changes from sub-electrode to sub-electrode due to the difference of the number and locations of the surrounding sub-electrodes.

It is very difficult to find the value of interconnecting impedance 85 using existing plasma theory. The impedance between top 80 and bottom 90 in FIG. 5d, i.e., the impedance seen by an individual sub-electrode, and its relationship with field/plasma uniformity can be found only by experiment using modeling and identification methods as will be discussed later.

The capacitively coupled plasma model illustrated in FIGS. 5a and 5b is described in further detail in Lieberman, M. A. and Lichtenberg, A. J., Principles of Plasma Discharges and Materials Processing, John Wiley & Sons: New York, N.Y. (1994). However, no prior study on the plasma model for the case of a partitioned upper electrode shown in FIG. 5c is known to exist. The model in FIG. 5d was created by Applicant.

The design of the RF feed must be tailored to the specific plasma electrode partition configuration and RF drive strategy. The differences between various RF drive strategies lie in whether the RF amplifier(s) or source(s) are located close to or remote from the sub-electrodes and whether match network(s) are used or not. Three exemplary embodiments for the RF feed are presented below.

FIG. 6 shows an RF connection arrangement for a plasma electrode composed of annular sub-electrodes 105. Each sub-electrode 105 has multiple RF connecting points, only two of which are illustrated in FIG. 6, to reduce the effect of RF propagation around annular sub-electrode 105. These multiple connections for each sub-electrode 105 are combined through coax cables 100 with a special length tailored for further RF transmission purposes, such as impedance transform, extending from an interface 95 which is made of conducting material to facilitate RF connection with a match network or directly with an RF power supply or RF amplifier. The shielding of coax cables 100 is grounded and reaches as close as possible to the back surface of sub-electrodes 105 to avoid RF interference among the sub-electrodes. The flexibility of coax cables 100 allows all RF connections for all annular sub-electrodes without any constructional difficulty.

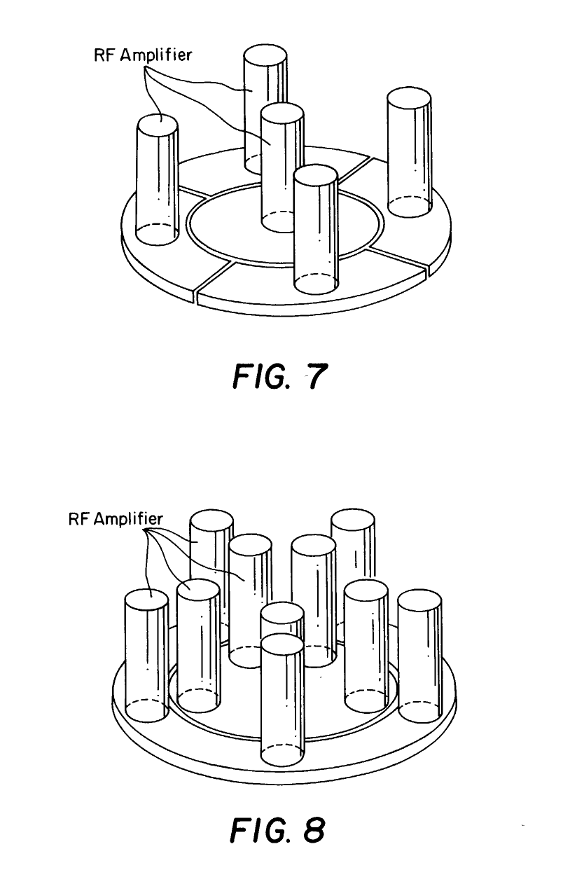

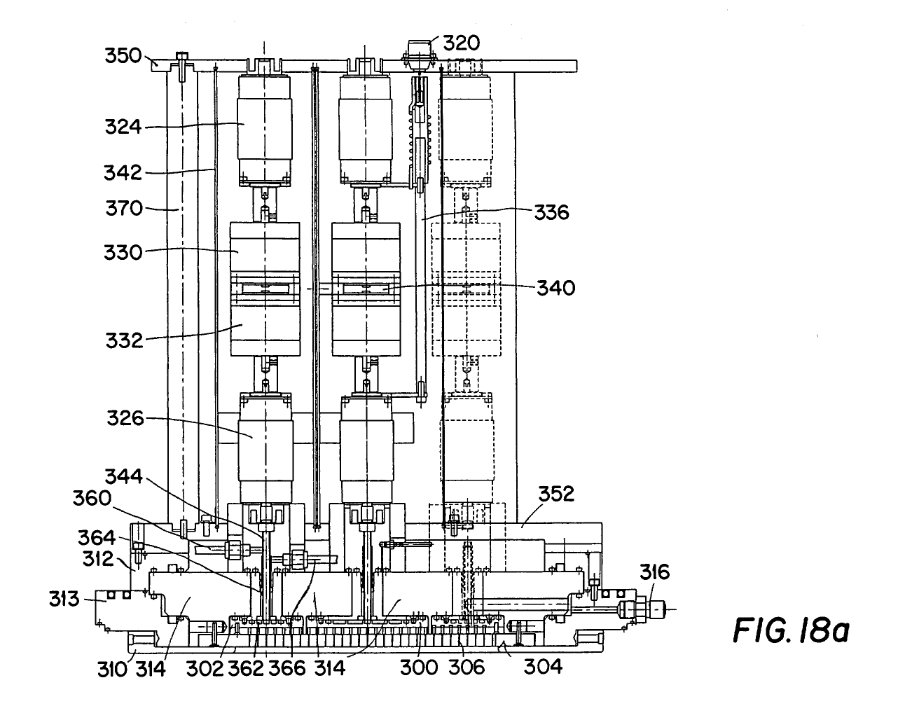

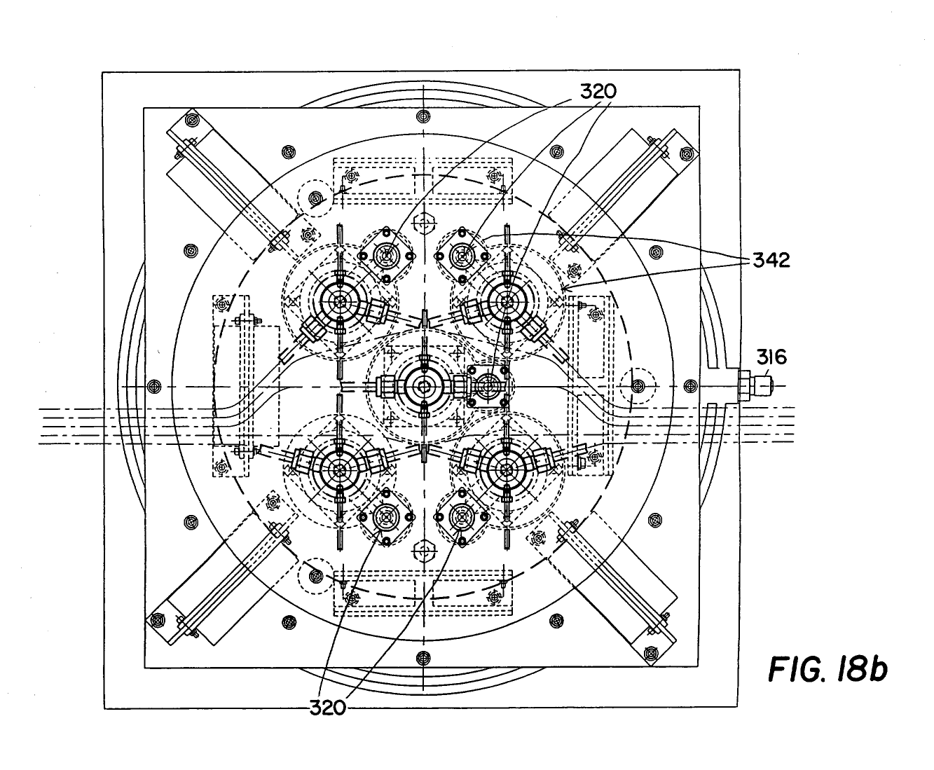

FIG. 7 shows a partitioned plasma electrode composed of five sub-electrodes. The area of each sub-electrode can be selected independently of the area of each of the other sub-electrodes to suit special uniformity needs, though equal areas may usually be preferred. Each sub-electrode is driven by power supplied directly by the output of a respective RF amplifier, which output is directly connected to the top of the respective sub-electrode. A match network can be incorporated into each RF amplifier when the situation requires. A more detailed illustration of apparatus according to the invention equipped with the plasma electrode arrangement of FIG. 7, and with gas flow and cooling elements, is shown in FIG. 18 which will be described below.

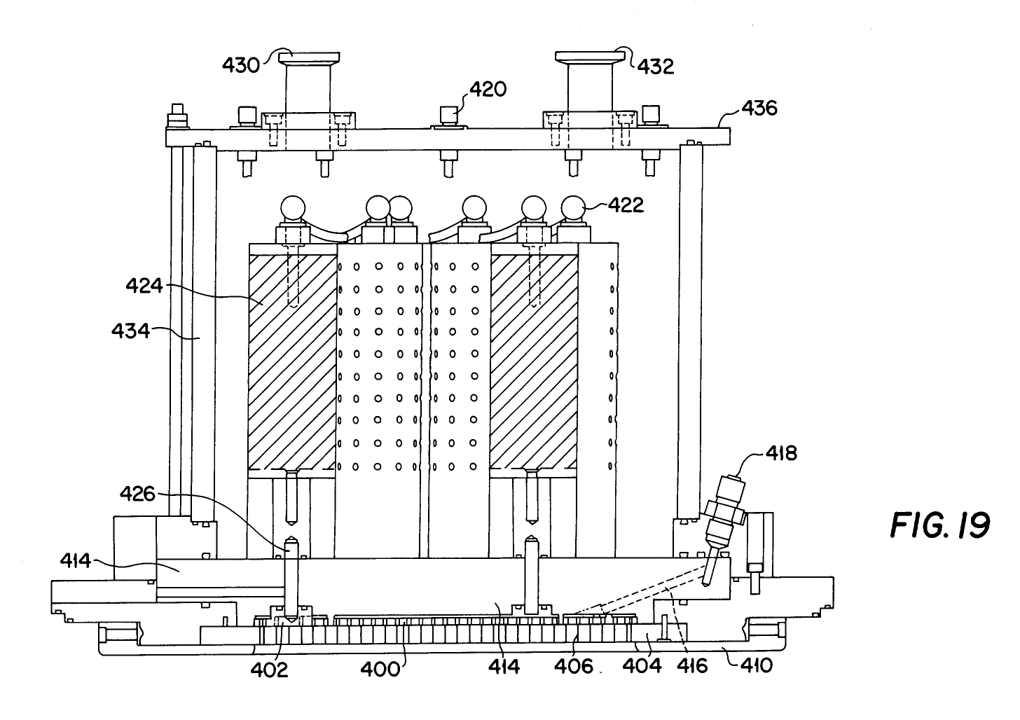

FIG. 8 shows a partitioned plasma electrode composed of two sub-electrodes. Each sub-electrode is here directly driven by multiple RF amplifiers. Multiple RF drives are preferred when the physical size of a sub-electrode is relatively large. Again, a match network can be incorporated into each RF amplifier when the situation requires. A more detailed illustration of apparatus according to the invention equipped with the plasma electrode arrangement of FIG. 8, and with gas flow and cooling elements, is shown in FIG. 19, which will be described below.

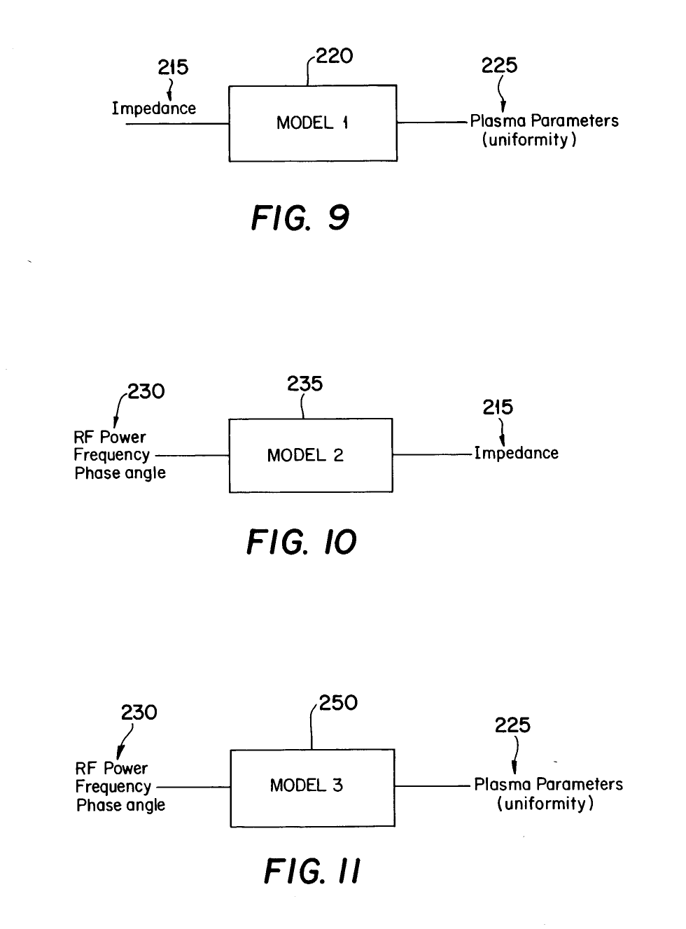

Selection of the optimum values of the RF variables (power level, frequency, phase angle, and waveform, etc.) for the individual sub-electrodes to control the overall uniformity of the result of a plasma processing operation for a given apparatus and process is based on the relationship among the variables in the models shown in FIG. 9, FIG. 10, and FIG. 11. Depending on the control algorithms used for the uniformity control being model based or not, the models (static or dynamic) in FIGS. 9, 10, and 11 may or may not need to be structure-identified and parameter-estimated.

FIG. 9 shows a diagram of modeling and parameter identification to build the relationship between the plasma electrode-to-bias electrode impedance and the internal plasma parameters. Specifically, model #1, 220 is a transform function between impedance 215 and internal plasma parameters 225. Uniform plasma means that the plasma parameters are the same from zone to zone. This also means that in theory, impedances are the same from sub-electrode to sub-electrode. However, different sub-electrodes may have respectively different surrounding environments. For example, there may be differences from one sub-electrode to another regarding the number and arrangement of other surrounding sub-electrodes and proximity to the chamber wall. Therefore, the impedance could be a little different from one sub-electrode to another even when the internal plasma parameters have the same values for all the zones, i.e., an overall uniform plasma. This impedance variation must be calibrated when impedance information is used for uniformity control. Because existing plasma theory is not able to predict the relationship between the impedance and plasma parameters, the modeling must be based on experimental measurements and modeling and identification techniques. Depending on the accuracy, simplicity, and analysis requirements, model types can be linear or nonlinear, analytical or numerical. But each model is multi-input, multi-output in general because the input vector, i.e., the impedance between plasma electrode, or each plasma sub-electrode, to be exact, and bias electrode contains in fact two independent variables, i.e., a real part and an imaginary part, and the output vector contains all internal plasma parameters such as plasma density, electron temperature, plasma potential, ion energy distribution, etc. Some of the internal plasma parameters may not be independent from each other. The dynamics can be neglected for the modeling purpose under consideration. Therefore, the model is a one-to-one map between the input and output. The signal flow can be bidirectional in the model and thus the model is static.

FIG. 10 shows a modeling diagram for a model #2 235 of the relationship between RF power, frequency and phase, etc. 230 of the RF source driving each plasma electrode and impedance 215.

FIG. 11 shows a modeling diagram for a model #3 250 of the relationship between RF power, frequency and phase etc. 230 and plasma parameters 225. Model 250 can be identified independently or can be derived from models 220 and 235 since there are only two independent models among these three.

The three models 220, 235 and 250 can be identified and their parameters can be estimated by any suitable methods, such as least squares estimates (LSE) or neural networks, etc. The models can be analytical or numerical.

For uniformity control purposes, if PD (proportional-differential) or PID (proportional-integral-differential) algorithm is used, only a confirmation of the relationship between the input and output in model 220 and the related calibration for impedances seen by all the sub-electrodes are needed. However, when advanced model-based control algorithms are considered for uniformity control, an explicit model will be needed.

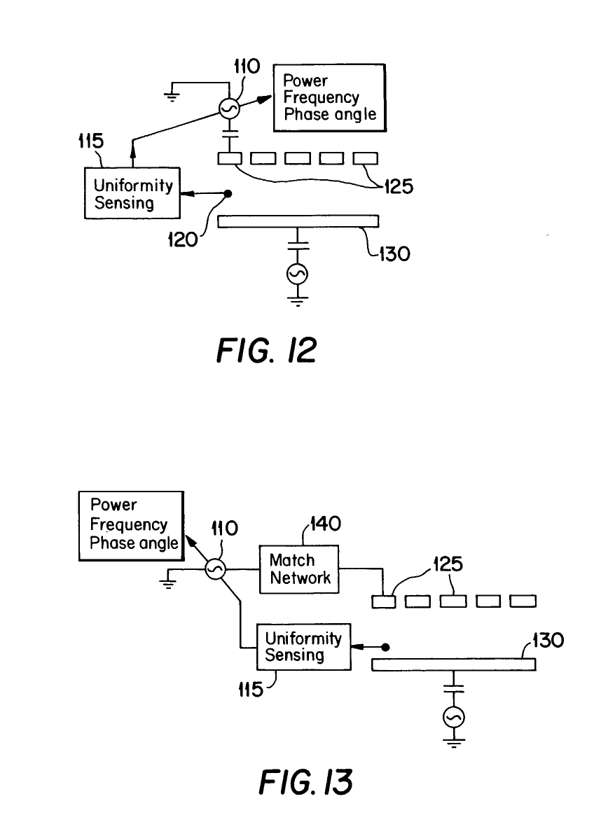

FIGS. 12-17 are schematic diagrams showing various arrangements for controlling the uniformity of a plasma created between the sub-electrodes of a plasma electrode and a bias electrode 130. In FIGS. 12-14 the connection of drive and control circuitry is shown with respect to only one sub-electrode, it being understood that identical circuitry is connected to each of the other sub-electrodes.

Because each of the sub-electrodes is coupled to a higher plasma impedance than a homogeneous electrode, it is advantageous to drive each sub-electrode by connecting a respective RF power supply 110 or RF amplifier directly to the top of each sub-electrode 125, i.e., without any intervening match network, as shown in FIG. 12, where uniformity control is achieved using direct plasma measurement apparatus 120 and a uniformity synthesizer, or sensor, 115 to assist the adjustment of RF power 110. Measurement apparatus 120 can be of one of the following known types: a scanning Langmuir probe; a scanning optical emission spectrometer (OES); or an interferometer. Any one of the above diagnostics can produce data that is either directly or indirectly related to the RF field distribution, whereby a correlation can be obtained.

This control scheme can be either on-line or off-line depending on whether real-time uniformity measurement under normal process conditions is available or not. As used herein, “off-line” refers to control settings made prior to wafer processing operations, “on-line” refers to control actions taken during wafer processing. The variables for RF adjustment could include the power level, voltage, current, frequency, phase angle and/or waveform, as discussed earlier. One feature of this control scheme is that no match networks are used due to the increase of impedance at each sub-electrode and the availability of RF power supplies in the market that are able to sustain 100% reflected power. However, power efficiency and cost-effectiveness must be taken into consideration before this control scheme is to be adopted in applications.

FIG. 13 shows a uniformity control scheme similar to that in FIG. 12, except that match networks 140 are used to ease the burden on the RF power supplies 110 and to increase RF power efficiency. This scheme can be accomplished off-line or on-line. The variables for RF adjustment could include the power level (as well as voltage or current), frequency, phase angle, and waveform. When modeling and parametric identification are considered, this scheme is readily capable of on-line control without explicit real-time measurement of uniformity due to the impedance self-sensing role of known match networks.

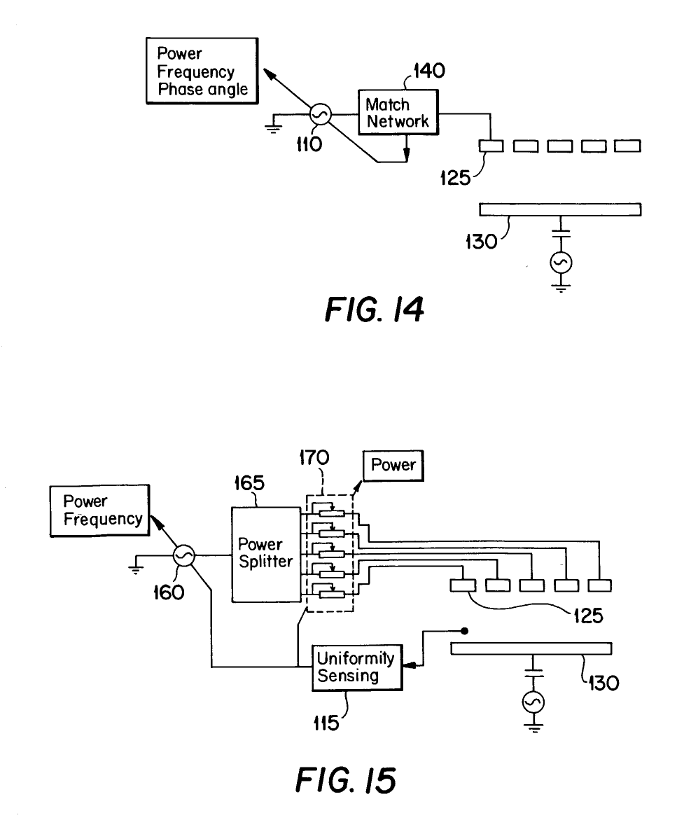

FIG. 14 shows an on-line uniformity control scheme, where each sub-electrode 125 has its own RF power supply 110 and match network 140. Match network 140 and power supply 110 of FIG. 14 are the same as those of FIG. 13. However, the feedback arrangement for adjustment of the amplitude, frequency, phase or waveform in FIG. 14 is different from that of FIG. 13. In FIG. 13, the feedback comes from an in-situ chamber diagnostic 115, similar to those listed above, that measures the spatial distribution of a plasma property. In FIG. 14, the feedback is from match network 140. As described above, the combined “matched” capacitor settings and inductance of the match network for each sub-electrode can be used to provide the information of the load impedance as seen by the match network. Therefore, the spatial variation of the plasma impedance, to the first order, can be derived from the match network electrical parameters. Using model #2, FIG. 10, the RF properties can be determined to equilibrate these impedances. Alternatively, the impedances may be used to infer the plasma properties through model #1, FIG. 9. This information can be used to tune the spatial variation of a particular plasma property.

Depending on the availability of the control variables on the RF power supply, i.e., power level (or voltage and/or current), frequency, phase angle, and waveform, the number of controllable plasma parameters will be different. More RF control variables correspond to more independently controllable plasma parameters. When one of the zones is tuned to the right plasma properties, the impedance of this zone becomes the reference for the uniformity control of other zones and the desired impedances of other zones can be found using this reference impedance and the calibration. Furthermore, the impedances coupled to the sub-electrodes are obtained from the corresponding match networks when the impedance match is achieved. This means that no additional impedance measurement and/or uniformity measurement is required in uniformity control. The self-sensing feature of match networks facilitates the on-line uniformity control without direct uniformity measurement.

The arrangements shown in FIGS. 15-17, the RF power can be set independently for each sub-electrode. At the same time, the RF frequency can be varied globally for all sub-electrodes.

FIG. 15 shows a uniformity control scheme where only one RF power supply 160 is needed because of the introduction of a power splitter 165 and a tuning mechanism 170 which independently vary the RF power level to each sub-electrode. An adjustable power splitter can also be used in place of power splitter 165 and tuning mechanism 170. This scheme can be on-line or off-line depending on whether real-time direct uniformity measurement is used or not. The variable for RF adjustment is limited to power level in this scheme. The tuning mechanism is controlled by the output of uniformity synthesizer 115. This output may be derived from a chamber diagnostic. Given this output, the RF power to each sub-electrode may be adjusted either manually or automatically. The simplicity of this scheme brings the trade-off of less controllability of plasma parameters and thus of uniformity. Commercially available power splitter/tuning mechanisms can be obtained from companies such as Daihen, etc.

FIG. 16 shows a uniformity control scheme similar to that in FIG. 15 but match networks 200 are used to increase RF power efficiency and to relieve the requirement for the RF power supply/splitter. While a tuning mechanism such as 170 adjusts the power level delivered to each sub-electrode, a match network such as 200 maximizes the transfer of this power to each sub-electrode by matching the load impedance. In doing so, the match network compensates for the reactive component of the plasma load, and when the load impedance is matched, the reflected power is minimized. This scheme can be implemented in an on-line fashion without direct uniformity measurement due to the existence of the match networks. Again, it has only one control variable, i.e., power level.

FIG. 16 further shows a plurality of tuned filters/traps 180, each connected between a respective sub-electrode 125 and ground, and thus in parallel with the plasma between sub-electrodes 125 and bias electrode 130. Each filter/trap can be tuned, by adjusting its variable capacitor, to minimize the electric field intensity at a selected harmonic of the supplied RF power, using the output of uniformity sensor 115 to determine when optimum tuning has been achieved. Thus, the purpose of the filter is to prevent RF power of a harmonic at the resonant frequency of the filter from being consumed or generated by the plasma. Each filter/trap 180 will be tuned individually. When used with a segmented electrode, even low Q filter/traps will provide effective attenuation of the selected harmonic.

Tuned filters/traps are able to effectively attenuate electric field energy in the plasma region because of the high plasma impedance observed at each of the sub-electrodes of the segmented plasma electrode compared with that of a conventional unsegmented electrode.

The application of filters/traps shown in FIG. 16 is applicable to all the configurations in FIGS. 12 to 17.

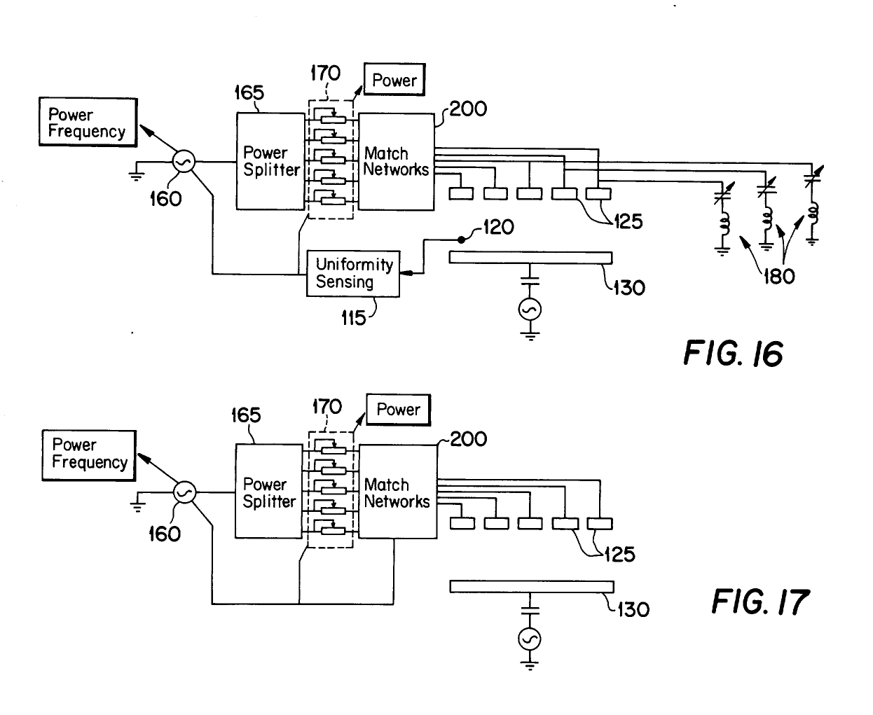

FIG. 17 shows a control scheme similar to that in FIG. 16 but with no direct uniformity measurement. The adjustment of RF power produced by supply 160 and of tuning mechanism 170 is based on the impedance information self-sensed by match networks 200. The capacitor positions, or settings, in each individual match network give an indication of the load impedance as seen by the match network. The derivation of the load impedance for each sub-electrode is correlated with the spatial distribution of various plasma properties. And, given this information, the RF power to each sub-electrode is adjusted to compensate for any non-uniformities in the above mentioned properties.

While a number of the arrangements described above include match networks, it should be noted that, because of the relatively high plasma impedance observed at each of the sub-electrodes, match networks can be omitted in certain cases.

FIGS. 18a and 18b are, respectively, an elevational view and a top plan view showing the upper portion of a processing chamber having a plasma electrode according to the present invention. The plasma electrode selected for this embodiment has the form shown in FIG. 3a and is composed of an inner disk 300 and four outer electrode segments 302. Two of these segments are visible in FIG. 18a. The plasma region will be located below the plasma electrode and the portions of the apparatus that are located below the components illustrated in FIG. 18a will be constructed in accordance with conventional practice in the art.

The plasma electrode forms a unit with a gas injection plate 304. The sub-electrodes 300, 302 and injection plate 304 are provided with gas injection orifices 306 through which process gas is introduced into the plasma region. A shield ring 310 is mounted below injection plate 304 and has an opening through which gas emerging from injection orifices 306 will pass into the process chamber. The primary purpose of the shield ring is to cover the injection plate fastener bolts in order to prevent arcing.

Shield ring 310 and injection plate 304 are both supported by a cover 312 of the processing chamber and sub-electrodes 300, 302 rest on, and are fastened to, injection plate 304. A metal adaptor 313 is provided to facilitate fittings, sealing, and cooling, etc.

FIGS. 18a and 18b show a prototype design that uses only RF power level as control variable to adjust uniformity, supplies power to each sub-electrode with a match network, and has the same electrode partition as that shown in FIG. 3a.

Cover 312 also supports an insulator 314 which acts to insulate the plasma electrode from cover 310 and which helps to insulate sub-electrodes 300, 302 from one another.

Gas injection orifices 306 are in communication with a gas inlet 316 via appropriate channels and plenums (not shown) in the sub-electrodes 300, 302. The channels are arranged to distribute gas equally to the plenums. A process gas which will be ionized to form the plasma is introduced via inlet 316 and the above-described channels and plenums to orifices 306.

RF power is supplied to each sub-electrode 300, 302 by a respective individual RF package. Each package is connected to a standard RF input 320 and is a columnar structure composed of two variable capacitors 324 and 326 each driven by a respective one of motors 330 and 332. In each columnar structure, a RF inductor 336 is connected between the two capacitors 324 and 326. Capacitors 324 and 326 and inductor 336 are connected to form a match network for the associated sub-electrode.

Motors 330 and 332 of each package are mounted on a mount plate 340. Mount plate 340 is affixed to a cylindrical conductive member 342 that encloses capacitors 324 and 326 and inductor 336. Conductive member 342 is grounded and serves as an individual RF radiation shield for the associated match network.

As shown in FIG. 18b, each conductive member 342 is composed essentially of two partial cylinders each fabricated from a tubular section of copper, the two tubular sections being brazed together to form the member. The smaller diameter tubular section fits around inductor 336 and the larger diameter tubular section fits around capacitors 324 and 326. All of the members 342 are sandwiched between, and fitted into grooves in, upper and lower plates 350 and 352 with spiral-shield inserted within each groove to insure a good electrical connection. Plates 350 and 352 are made of a conductive material and are grounded. A spiral-shield comprises an inner rubber seal encircled by a spiral conductor and is a commonly used method to seal areas of the chamber and maintain a good electrical contact.

Each columnar structure further includes the associated sub-electrode itself and a RF feed 344 that is connected between bottom capacitor 326 and the associated sub-electrode.

Each RF feed 344 and sub-electrode 300, 302 is cooled with a coolant having dielectric properties, for example Fluorinert®. The coolant flow system for each sub-electrode includes a coolant inlet line 360, a flow passage (not shown) along the axis of the associated RF feed 344, channels 362 in the surface of the sub-electrode, an outer annular passage 364 concentric with RF feed 344 and an outlet line 366.

The illustrated apparatus further includes a grounded cylindrical outer conductive shield which provides shielding for the RF system.

FIG. 19 shows a second embodiment of the portions of a processing chamber associated with the plasma electrode, which embodiment includes components similar to those shown in FIG. 18.

In the embodiments shown in FIG. 19, the plasma electrode has two sub-electrodes, including an inner disk 400 and a circular, annular outer ring 402. Thus, the plasma electrode has the form shown in FIG. 8. The plasma electrode is associated with a gas injection plate 404 and is provided with gas injection orifices 406. The plasma electrode and plate 404 are associated with a shield ring 410 which performs the same function as shield ring 310 of FIG. 18a. Insulators 414 are disposed above the plasma electrode and extend between inner disk 400 and outer ring 402.

Process gas is supplied to orifices 406 via gas lines 416 and plenums, as describe above with reference to FIG. 18a, and one or more gas inputs 418.

RF power is supplied to sub-electrodes 400, 402 via RF power inputs 420, connectors 422, RF power amplifiers 424 and RF feeds 426. The holes, or perforations in amplifiers 424 are provided to permit the flow of coolant into and out of the RF enclosures. The RF power system may also be constructed in the same manner as that described with reference to FIG. 18. The plasma electrode is provided with a coolant system to which coolant is supplied via an inlet 430 and withdrawn via an outlet 432.

The RF components are surrounded by an outer conductive shield 434.

As is apparent from FIG. 19, all of the described components are supported by an upper support plate 436.

All of the components for generating RF power, for transferring that power to the electrodes, for monitoring plasma uniformity and controlling RF power generation, phase shifts and power distribution to the sub-electrodes may be constituted by devices and systems that are already well-known in the art.

Depending upon the available type of response of the diagnostic used to determine the spatial variation of the measurable quantity, it may be possible to infer from the time series of the measurement the spectral content by transforming time domain data into frequency domain data (using a complex FFT). In the frequency domain, one may be presented with the relative amplitudes of the frequency contents of the measurement under study. One may also interpret several “spikes” to be associated with the harmonics of the fundamental drive frequency. Given this harmonic signature of the measurable quantity, a pre-determined distribution of harmonic power may be superposed upon the fundamental RF drive frequency to compensate the measured spectral content and/or enhance a particular component. It comprises a unique distribution of harmonic amplitudes prescribed by the measurement of spectral content of a particular system property.

As used herein, electric field uniformity is a measure of the amount of variation, relative to an average value of the electric field strength in the radial direction of, and along the surface of, the bias electrode. The smaller the variation, the better the uniformity.

The dimensions of each sub-electrode will be dependent in part on the diameters of the substrate, or wafer, to be processed and the entire segmented electrode. The diameter of an un-partitioned plasma electrode is usually a little bigger than that of the wafer to be processed. If an 8-inch diameter plasma electrode is to be partitioned into five sub-electrodes with equal areas and a partition pattern as shown in FIG. 3a, the diameter of the central sub-electrode is 3.58 inches. The dimensions of the other four sub-electrodes on the outer ring can be easily determined from the above dimensions.

For a given set of process parameters, or a given recipe, a globally uniform plasma, or globally uniform etch or deposition profile, corresponds to a specific set of sub-electrode impedances seen by the match networks of the individual sub-electrodes. This set of sub-electrode impedances is designated herein uniform reference (U.R.) impedances.

The plasma impedance at each sub-electrode can be sensed by the corresponding match network when the impedance of that network has been set to match the plasma impedance. At the match point, the plasma impedance at each sub-electrode is the conjugate of the output impedance of the corresponding match network. The output impedance of that match network can be calculated using its topology and component values. The components of a match network include, as shown, for example, in FIG. 18a, fixed components, such as inductors, and variable components, such as capacitors. The impedance of a match network is varied by performing a mechanical movement, as by rotating motors 330 and 332 in the device shown in FIG. 18a. The values of the fixed components are known from the design of the match networks. The values of the variable components can be read from the real-time position of a component which produces, or is coupled to respond to, the mechanical movement. For example, motors 330 and 332 may be stepper motors operated by a motion control mechanism having an encoder whose angular position can be read.

When each match network is individually tuned to its own match point by its own controller based on the corresponding RF power for the specific sub-electrode, it does not necessarily mean that the plasma is globally uniform. For given process parameters, when the plasma is not globally uniform, the actual impedance seen by each match network does not necessarily correspond to U.R. impedance for the associated sub-electrode. Rather, each match network senses the actual plasma impedance for its own sub-electrode.

According to the present invention, a control arrangement is provided to compare the actual impedance of each sub-electrode with its corresponding U.R. impedance, and the difference therebetween is used to provide a regulating error signal to adjust one or more of the available control variables for the RF power supplied to the associated match network. These variables can include RF power level, phase angle, frequency and waveform.

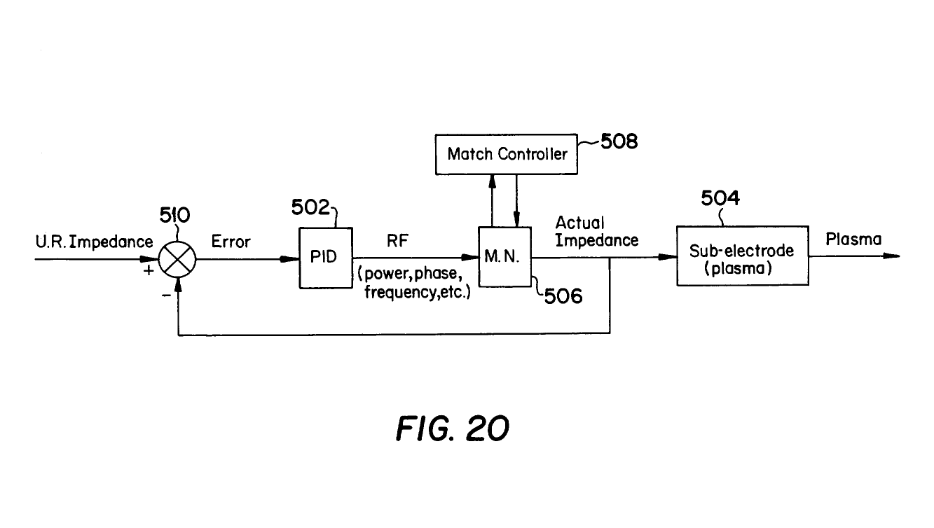

One exemplary embodiment of such a control arrangement is shown in FIG. 20. This arrangement includes a PID controller 502, although other types of controllers can be used. Controller 502 controls the parameters of the RF power delivered to an associated sub-electrode 504 via a match network 506. The impedance of match network 506 is adjusted in a conventional manner by a match controller 508 to match the impedance of match network to the plasma impedance as seen by the associated sub-electrode 504. The plasma impedance is a function of the parameters of the RF power.

A signal representing the actual match network impedance is derived from a component representing the actual value of a variable component of match network 506, for example from the previously-mentioned encoder. This signal is supplied to a comparator or error detector 510. A signal representing the U.R. impedance value for the same sub-electrode is also supplied to comparator 510. The difference between the two input signals constitutes an error signal that is supplied to a control input of controller 502. Controller 502 is arranged to vary one or more of the RF power parameters in a direction to cause the resulting plasma impedance to equal the associated U.R. impedance.

The control gains of controller 502 are designed and tuned to stabilize the system with desired regulation performance. That is, during a control transient the actual impedance converges to its corresponding U.R. value in a desired period of time.

The extent to which the uniformity of a plasma-assisted process will be improved by use of control arrangements of the type shown in FIG. 20, will be dependent in part on proper selection of the U.R. impedance values. Plasma impedance, and/or sub-electrode impedance, may be related to plasma properties, and plasma impedance, and/or sub-electrode impedance, information can be used to identify overall plasma uniformity and/or to estimate internal parameters/properties of the plasma. Such data can be incorporated into a look-up table, data base, or curves which can then be accessed by controller 502 to determine the appropriate RF parameter adjustment direction for a given set of process parameters, excluding RF parameters, the corresponding U.R. impedance, and the actual impedance at the specific sub-electrode. During a regulating procedure, interpolation may be used to cover the gap between the measurements made in modeling.

To obtain the desired data, a modeling and identification experimental procedure is undertaken in which plasma impedance measurements can be made with each match network tuned to its match point, as described above. At the same time, when the plasma impedance at each sub-electrode is sensed by its match network during this procedure, the plasma properties are measured by using one or more of the well-known types of diagnostic devices: Langmuir probe, optical emission spectrometer, and interferometer, etc. Comparison among the plasma properties measured at each sub-electrode gives the information of the global plasma uniformity.

For example, the global ion density uniformity (GIDU) in the radial direction can be calculated as:

GIDU=max(1≦i≦3) (ID₁, ID₂, ID₃))/avg(ID₁, ID₂, ID₃)*100%,

where max( ) is the maximum value function, ID₁ is the ion density under the i^{th} (i=1,2,3) sub-electrode at the corresponding measurement location chosen to characterize that sub-electrode, and avg( ) is the average function. The global uniformity of other plasma properties can be defined and calculated in the same way as described. In addition, the ultimate process uniformity measurement method, which involves etching wafers and measuring etch rate on wafers, can also be used. The global etch uniformity is defined and calculated in a similar way. It must be noted that all of the possible process parameters, including RF parameters, are scanned during the modeling and identification procedure, and the corresponding data sets are taken for each set of process parameters. These data sets are arranged into a look-up table or look-up data base to build a mapping relationship between plasma impedance and plasma/field/etch uniformity, or even uniformity of plasma properties as a whole. The look-up table or data base can be further fit into curves when needed. For a given set of etch rates under the individual sub-electrodes and for a given set of process parameters, when the set corresponds to a global uniform etch profile, the corresponding set of plasma impedances for the corresponding sub-electrodes is designated as the corresponding uniform reference (U.R.) impedances.

The results produced by processes performed in apparatus according to the invention are also influenced by the adjustment and control of the spatial distribution of the neutral process gas flow and pressure above the substrate on which the process is being performed. In general, one primary mechanism for adjusting the neutral flow conditions is the design of the gas injection plate or interface that introduces the gaseous species to the low pressure environment of the plasma region. Typically, a flat “shower-head” injection plate is employed to produce a uniform introduction of the process gas to the low pressure environment and subsequently provide a low-speed gas flow that “showers” down onto the substrate. A conventional injection plate comprises a plurality of equal diameter orifices that are equally distributed throughout the injection region, i.e. that have a spatially homogeneous number density. The orifices are supplied from above the plasma electrode with a homogeneous pressure field and, hence, produce a homogeneous introduction of the mass flow into the process chamber.

In certain cases, compensation for inherent non-uniformities and improved process uniformity, can be achieved by adjusting the spatial distribution of the inlet mass flow and/or gas species in order to adjust the resultant neutral flow pressure field and flow dynamics in conjunction with other process parameters, such as the RF field.

In the prior art, this has been achieved by adjustment of the mass flow to a plurality of sub-orifices, with the capability for in-situ adjustment of the mass flow distribution. However, these solutions involve fairly complex and expensive plumbing arrangements for gas injection.

According to the present invention, the physical segmentation of the upper electrode readily accommodates and actually necessitates independent gas delivery to each sub-electrode. As a result, it is a simple matter to alter the spatial distribution of the gas flow and/or species concentration by adjusting the gas flow parameters of each sub-electrode.

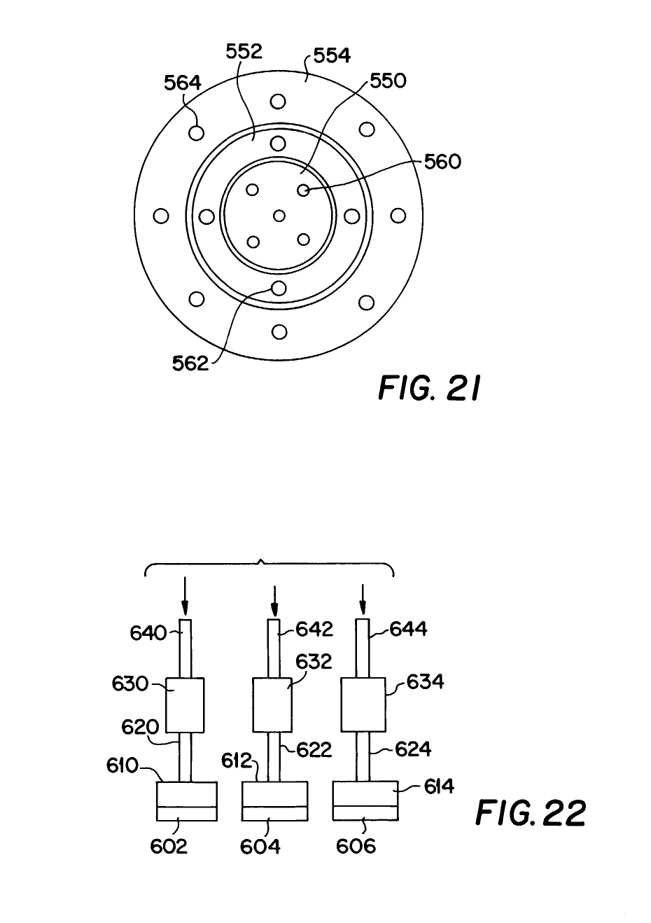

According to one embodiment, all sub-electrodes may be supplied from the same source, yet the number of holes, the size of the holes, and/or the spacing between holes for each sub-electrode may be varied from one sub-electrode to another. One example of such an embodiment is shown in FIG. 21, which is a pictorial plan view of an electrode having three concentric sub-electrodes 550, 552 and 554. Central sub-electrode 550 is provided with an array of relatively small diameter holes 560 having a first mutual spacing. Intermediate sub-electrode 552 is provided with an array of relatively large diameter holes 562 having a second mutual spacing which is greater than the first mutual spacing. Outer sub-electrode 554 is provided with an array of holes 564 each having a diameter greater than that of holes 560 and less than that of holes 562. Holes 564 have a third mutual spacing which is greater than the first mutual spacing and smaller than the second mutual spacing. The number of holes 560 is greater than the number of holes 562 and less than the number of holes 564. The illustrated relative hole diameters, mutual hole spacings and numbers of holes from one sub-electrode to another represent only one example; this embodiment of the invention can have many other combinations of these parameters.

According to a second embodiment, the flow of gas to each sub-electrode or group of sub-electrodes may be independently controlled with separate mass flow controllers. Thereby, one may directly alter the mass flow delivered to each sub-electrode. Furthermore, if injection is accomplished via sonic orifices, a pressure regulator may be used to alter the total pressure behind each sub-electrode injection plate and, in turn, alter the gas density. For a sonic orifice, the velocity is fixed at the throat (i.e. local speed of sound) and since the area is fixed, the volume flow rate is invariant. Therefore, given fixed area orifices, the only means to change the mass flow is to adjust the gas density. Moreover, any combination of the above may be employed.

One arrangement according to this second embodiment is shown in FIG. 22. Three sub-electrodes 602, 604 and 606 are each provided with an array of gas flow passages (not shown). Each sub-electrode is surmounted by a respective gas flow plenum 610, 612, 614, each connected via respective conduit 620, 622, 624 to a respective gas flow control device 630, 632, 634. Each gas flow device receives process gas from a gas supply source (not shown) via a respective input conduit 640, 642, 644. Each flow device 630, 632, 634 may be a mass flow controller, a pressure regulator, or any other type of device capable of controlling the rate of flow of process gas.

In addition to the mass flow rate, the species concentration may be varied to each sub-electrode. This can directly affect the plasma and etch chemistry locally. Conventional computer controlled gas injection manifolds may be employed to adjust both the gas flow rate and gas type to each sub-electrode.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for generating and controlling a plasma formed in a capacitively coupled plasma source having a plasma electrode and a bias electrode, the plasma electrode being composed of a plurality of sub-electrodes that are electrically insulated from one another and the plasma being formed in a plasma region between the plasma electrode and the bias electrode, said method comprising:
coupling RF power to the plasma region via each sub-electrode; and
causing the RF power coupled via one of the sub-electrodes to be able to differ in at least one of frequency, phase and waveform from the RF power coupled via another one of the sub-electrodes.

2. The method of claim 1 wherein the RF power coupled via the one of the sub-electrodes is able to differ in frequency from the RF power coupled via the other one of the sub-electrodes.

3. The method of claim 1 wherein the RF power coupled via the one of the sub-electrodes is able to differ in phase from the RF power coupled via the other one of the sub-electrodes.

4. The method of claim 1 wherein the RF power coupled via the one of the sub-electrodes is able to differ in frequency and phase from the power coupled via the other one of the sub-electrodes.

5. The method of claim 1 wherein the RF power coupled via the one of the sub-electrodes is able to differ in at least two of magnitude, frequency, phase and waveform from the power coupled via the other one of the sub-electrodes.

6. The method of claim 1 further comprising causing the RF power coupled via the one of the sub-electrodes to be able to differ in magnitude from the RF power coupled via the other one of the sub-electrodes.

7. The method of claim 1 wherein the plasma electrode has a center axis and the sub-electrodes are arranged eccentrically with respect to the center axis.

8. The method of claim 1 wherein said step of coupling RF power to the plasma region via each sub-electrode comprises coupling an RF power source directly to each sub-electrode.

9. The method of claim 1 wherein the RF power source is coupled directly to each sub-electrode with no intervening match network.

10. Apparatus for generating and controlling a plasma, comprising:
a capacitively coupled plasma source composed of a plasma electrode and a bias electrode, said plasma electrode being composed of a plurality of sub-electrodes which are electrically insulated from one another and said plasma electrode being spaced from said bias electrode by a plasma region in which the plasma is formed; and
RF power supply means connected to said sub-electrodes for coupling RF power into the plasma region via said sub-electrodes to generate and sustain the plasma,
wherein said RF power supply means are operative for causing the RF power coupled via one of said sub-electrodes to be able to differ in at least one of frequency, phase and waveform from the RF power coupled via another one of said sub-electrodes.

11. The apparatus of claim 10 wherein said RF power supply means are operative for coupling RF power via the one of said sub-electrodes which is able to differ in frequency from the RF power coupled via the other one of said sub-electrodes.

12. The apparatus of claim 10 wherein said RF power supply means are operative for coupling RF power via the one of said sub-electrodes which is able to differ in phase from the RF power coupled via the other one of said sub-electrodes.

13. The apparatus of claim 10 wherein said RF power supply means are operative for coupling RF power via the one of the sub-electrodes which is able to differ in frequency and phase from the RF power coupled via the other one of the sub-electrodes.

14. The apparatus of claim 10 wherein said RF power supply means are operative for coupling RF power via the one of the sub-electrodes which is able to differ in at least two of magnitude, frequency, phase and waveform from the RF power coupled via the other one of the sub-electrodes.

15. The apparatus of claim 10 wherein said RF power supply means are operative for coupling RF power via the one of said sub-electrodes which is able to differ in amplitude from the RF power coupled via the other one of said sub-electrodes.

16. The apparatus of claim 10 wherein said plasma electrode has a center axis and said sub-electrodes are arranged eccentrically with respect to the center axis.

17. The apparatus of claim 10 wherein said plasma electrode has a center axis and all of said sub-electrodes are circular and concentric with respect to said center axis.

18. The apparatus of claim 10 wherein said plasma electrode has a center axis and said sub-electrodes include a central electrode that intersects the center axis and a plurality of peripheral electrodes spaced apart around said center electrode.

19. The apparatus of claim 10 wherein said RF power supply means comprise a plurality of individually controllable power supplies each connected to only a respective one of said sub-electrodes.

20. The apparatus of claim 19 wherein said RF power supply means comprise a plurality of impedance match networks each connected between a respective power supply and a respective sub-electrode.

21. The apparatus of claim 10 wherein said RF power supply means comprise a single power supply and power distribution means for distributing power from said RF power supply to all of said sub-electrodes.

22. The apparatus of claim 21 wherein said distribution means comprise a power splitter.

23. The apparatus of claim 22 wherein said distribution means further comprise a tuning mechanism connecting said power splitter to all of said sub-electrodes.

24. The apparatus of claim 10, further comprising a plurality of tuned filters each connected to a respective one of said sub-electrodes for attenuating an electric field component in the plasma region at a specific harmonic of the RF power supplied to the plasma region.

25. Apparatus for generating and controlling a plasma, comprising:
a capacitively coupled plasma source composed of a plasma electrode and a bias electrode, said plasma electrode being composed of a plurality of sub-electrodes which are electrically insulated from one another and said plasma electrode being spaced from said bias electrode by a plasma region in which the plasma is formed;
RF power supply means connected to said sub-electrodes for coupling RF power into the plasma region via said sub-electrodes to generate and sustain the plasma; and
a plurality of tuned filters each connected to a respective one of said sub-electrodes for attenuating an electric field component in the plasma region at a specific harmonic of the RF power supplied to the plasma region.

26. A method for generating and controlling a plasma formed in a capacitively coupled plasma source having a plasma electrode and a bias electrode, the plasma electrode being composed of a plurality of sub-electrodes that are electrically insulated from one another and the plasma being formed in a plasma region between the plasma electrode and the bias electrode, the plasma being coupled to each sub-electrode so that a respective plasma impedance value is observed at each sub-electrode, said method comprising:
coupling RF power to the plasma via each sub-electrode by supplying RF power to each sub-electrode via a respective controllable match network from a respective controllable power source;
adjusting each match network to have an output impedance that is matched to the respective plasma impedance value observed at the respective sub-electrode; and
adjusting the RF power supplied by each power source in a direction to cause the respective plasma impedance value observed at each sub-electrode to have a respective reference value.

27. The method of claim 26 wherein said step of adjusting the RF power comprises, for each sub-electrode;
obtaining, from the respective match network, a measured value representative of the actual respective plasma impedance value;
comparing the measured value with the respective reference value to obtain an error value representing the difference between the respective measured and reference value; and
varying the RF power in a direction to reduce the error value.

28. A method for determining reference values for plasma impedance as observed by each of a plurality of individual subelectrodes of a plasma electrode in a capacitively coupled plasma source, said method comprising:
operating the plasma source under a succession of different sets of operating conditions;
during operation under each set of operating conditions, measuring plasma impedance as observed at each sub-electrode and a selected parameter of the plasma adjacent each sub-electrode;
determining which one of the different sets of operating conditions produces the most desirable values for the selected parameter of the plasma; and
selecting, as the reference values, the measured plasma impedance associated with the set of operating conditions determined to produce the most desirable values for the selected parameter of the plasma.

29. The method of claim 28 wherein the selected parameter of the plasma can be ion density, or electric field strength, or direct etch rate on a wafer at the areas under the corresponding sub-electrodes, or any other plasma property related parameter to characterize the uniformity of the global plasma region.

30. Apparatus for generating and controlling a plasma, comprising:
a capacitively coupled plasma source composed of a plasma electrode and a bias electrode, said plasma electrode being composed of a plurality of sub-electrodes which are electrically insulated from one another and said plasma electrode being spaced from said bias electrode by a plasma region in which the plasma is formed, each of said sub-electrodes being provided with a plurality of gas flow passages communicating with the plasma region;
RF power supply means connected to said sub-electrodes for coupling RF power into the plasma region via said sub-electrodes to generate and sustain the plasma; and
process gas delivery means communicating with said plurality of gas flow passages for supplying process gas to all of said passages.

31. The apparatus of claim 30 wherein each of said gas flow passages has a cross-sectional area and the sum of the cross-sectional areas in one of said sub-electrodes is different from the sum of the cross-sectional areas in another one of said sub-electrodes

32. The apparatus of claim 30 wherein said gas flow passages in one of said sub-electrodes differ from said gas flow passages in another one of said sub-electrodes with respect to at least one of: the number of gas flow passages; cross-sectional area of each gas flow passage; and the spacing between gas flow passages.

33. The apparatus of claim 30 wherein said process gas delivery means comprise flow rate control means for individually controlling the rate of flow of process gas to each of said sub-electrodes.

34. The apparatus of claim 33 wherein said flow rate control means comprise a plurality of flow rate control devices each communicating with said gas flow passages of a respective one of said sub-electrodes.

35. The apparatus of claim 34 wherein each of said flow rate control devices is a mass flow controller or a pressure regulator.

36. The apparatus of claim 30 wherein said RF power supply means are operative for causing the RF power coupled via one of said sub-electrodes to be able to differ in at least one of frequency, phase and waveform from the RF power coupled via another one of said sub-electrodes.
